(19) United States
(12) Patent Application Publication
(10) Pub. No.: US 2009/0051556 A1
(43) Pub. Date: Feb. 26, 2009

(54) OPTICAL NETWORK TERMINAL BACKUP BATTERY VOLTAGE ALERT

(75) Inventors: Randy B. McCain, Fort Washington, MD (US); Henry A. McKelvey, Capitol Heights, MD (US)

Correspondence Address: VERIZON;PATENT MANAGEMENT GROUP, 1320 North Court House Road, 9th Floor, ARLINGTON, VA, 22201-2909, US

(73) Assignee: VERIZON SERVICES CORP., Arlington, VA (US)

(21) Appl. No.: 11/842,306

(22) Filed: Aug. 21, 2007

(51) Int. Cl. G08B 21/00

(52) U.S. Cl. 340/636.1

(57) ABSTRACT

An optical network terminal (ONT) battery backup unit (BBU) battery voltage alert system (BVAS). The BVAS can send multiple alerts via email, pager, land-line telephone, wireless telephone, fax, personal digital assistant (PDA), etc. when the backup battery voltage is less than its full voltage. The alerts can be categorized as “marginal” or “bad” depending on degree of battery voltage depletion. Less than full battery voltage can result from battery usage if there is a utility company power outage, or if a cell in the battery fails even if there is no power outage. The alerts can be sent to the customer of the ONT, to the ONT supplier company so it can offer any assistance it can and to a third party monitoring service which can keep track of the history of all such deployed batteries in the customer base of the ONT supplier. This alert is provided as a supplement to an audio alarm which sounds when the backup battery is discharging because that alarm may not be heard in sufficient time if the alarm is remotely located relative to its customer, e.g., in the customer's basement or outside.

### BACKGROUND

Fiber optic infrastructure is currently being deployed by the assignee of the present invention with its fiber-optic system program, and is being operatively connected to its customer base. Fiber optic telecommunication infrastructure offers many advantages over the old standard copper wire cabling, not the least of which is vastly increased bandwidth. “Plain old telephone service” (POTS) had operated, and still operates, with copper wiring. POTS is now being made compatible with fiber optic cabling, such as in passive optical networks (PONs).

However, providing POTS service in combination with this new PON fiber optic infrastructure involves certain optically-related and/or other functionality not previously needed in the copper wire cabling world. For example, an optical line terminal (OLT) is needed which may be located in the central office of the relevant telecommunications company or at some other regional location (but not on customer premises). The OLT is communicatively coupled via fiber optic cable to an optical network terminal (ONT) which can be located immediately outside of a customer's premises on an outside wall some four to five feet above ground, or can be located inside a customer's premises such as in a basement.

The ONT includes and is powered by a power supply such as, for example, a power supply similar, or related, to that described in patent application Ser. No. 11/144,566 filed Jun. 3, 2005, and incorporated herein by reference in its entirety. That patent application is entitled “Multi-Component ONT Power Supply” and its assignee is in common with that of the instant application. That patent application claims benefit of provisional application Ser. No. 60/576,675 filed Jun. 3, 2004. That power supply is, in turn, powered by typical electric utility company power which is subject to power failure for any number of reasons including, for example, power company equipment failure, local or national emergencies, natural disasters, terrorist attacks, etc.

During a utility company power failure, traditional POTS telephone service over copper wiring is ordinarily able to continue because of POTS battery back-up infrastructure which is in place at telecommunication company central offices. This battery backup system is designed to maintain POTS telephone service for an entire community. But, that otherwise available POTS telephone service will not be available to a telephone customer using a PON system, if the ONT cannot communicate with the OLT over the fiber optic cable because the ONT lacks power due to that power failure.

To this end, battery backup has also been provided within the ONT and within the environment for the ONT, and for customer telephone instruments connected to that ONT. But, in contrast with the central office location of POTS battery backup, ONT battery backup is located proximate its associated ONT. This ONT battery backup unit (BBU) can be designed to include certain customer-useful features. One such feature is an audio alarm which sounds when the backup battery voltage level is low. For example, application Ser. No. 11/460,499, filed Jul. 27, 2006, entitled: “Optical Network Terminal Power Failure Management” relates to managing a low ONT battery voltage audio alarm; this application is assigned to the assignee of the instant application and is incorporated herein by reference in its entirety.

However, a sounding-alarm, if battery voltage is low due to utility company power failure, or for other reasons, is not always heard by the customer in sufficient time for the customer to take appropriate action, particularly if the ONT is installed in a relatively remote place on the customer's premises, such as outside of the house or in the basement. Under certain conditions, such an alarm can be sounded for several hours and never be heard by occupants of the customer's premises. The backup battery can be discharged completely during that critical time period. If the backup battery is completely discharged and, on the one hand, if that battery discharge was due to a utility company power failure, then communication services via the ONT would be completely unavailable unless and until power is restored by the power company. On the other hand, if battery discharge was due to other reasons, the battery is then useless if needed for backup purposes if and when there is a utility company power failure.

### BRIEF DESCRIPTION OF THE DRAWINGS

FIG. 1 is an exemplary block diagram of an ONT arrangement in a customer premises environment with which embodiments made in accordance with principles of the present invention are particularly useful;

FIG. 2 is an exemplary block diagram of a BBU battery voltage alert system in operative connection in a network context, in accordance with principles of the present invention; and

FIG. 3 is a flowchart of operation of an embodiment of the present invention.

### DETAILED DESCRIPTION OF PREFERRED EMBODIMENTS

When a backup battery for an ONT is discharging because it is backing-up the ONT during a utility company power outage, or has a voltage level less than full voltage due to a failed battery cell or for any other reason, an audio alarm is normally sounded. If that audio alarm cannot be heard, where the battery may run down completely without warning to the customer, embodiments of the present invention provide multiple alerts to the customer via email, pager, land-line telephone, wireless telephone, fax, PDA and any other available telecommunication connection. These alerts, or a subset of them, can also be forwarded to the supplier of the ONT, and even to a third party monitoring service.

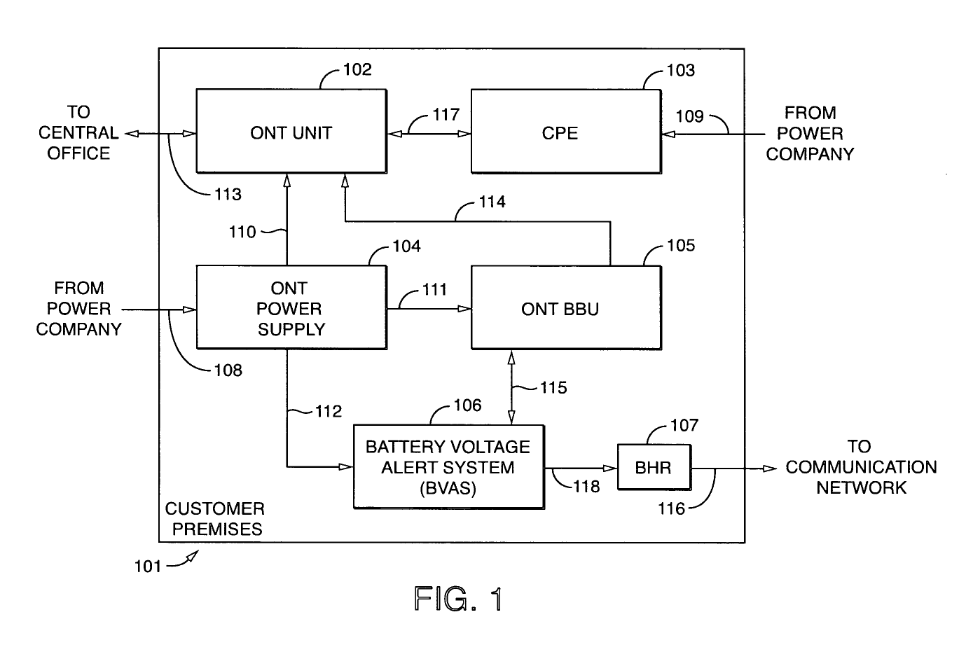

FIG. 1 is an exemplary block diagram of an ONT relationship with customer premises equipment (CPE) in a customer premises environment, with which embodiments of the present invention are particularly useful. Customer premises 101 may be, for example, a single family house and includes: customer premises equipment (CPE) 103, ONT unit 102, ONT power supply 104, ONT battery backup unit (BBU) 105, battery voltage alert system (BVAS) 106 and broadband home router (BHR) 107. CPE 103 includes, without limitation, e.g., telephone, television, computer, fax machine, etc., not shown.

Power from a utility company is supplied to premises 101 via power lines 108 at the left-hand side of the drawing and 109 at the right-hand side of the drawing. Power line 109 powers all CPE 103 (including appliances, etc., not shown). Power line 108 supplies power to ONT power supply 104 which, in turn, supplies power to ONT unit 102, ONT BBU 105 and BVAS 106 via power lines 110, 111 and 112 respectively. ONT UNIT 102 is operatively coupled to CPE 103 via bus 117 (which represents both a bidirectional communication bus and a power connection to CPE 103 from ONT BBU 105 via power bus 114 and ONT UNIT 102 during power failure). ONT BBU 105 is operatively coupled to ONT unit 102 via power bus 114 during power outages, to supply power to ONT unit 102 during power outages.

ONT BBU 105 is also operatively coupled to BVAS 106 via bus 115 (which represents a bidirectional communication bus and a power connection from ONT BBU 105 to BVAS 106 during power failure). Alerts from BVAS are coupled to BHR 107 via output link 118. BHR 107 outputs the alerts to a communication network on line 116. Communication input to, and communication output from, ONT UNIT 102 is provided over optical fiber line 113 which is connected to an OLT in a central office of a telecommunication company that supplied the ONT arrangement to the customer. Operation of certain of the equipment in FIG. 1 is further discussed in the incorporated by reference patent application entitled: “Optical Network Terminal Power Failure Management.”

Under normal conditions of no power outage at the power company, power supply 104 powers not only the ONT unit 102, but also continuously charges a battery (not shown in this Fig.) located within ONT BBU 105 in an attempt to keep it fully charged for backup purposes, in the event of a power outage and also powers BVAS 106 which monitors battery voltage. Under these normal operating conditions, communication information can be received on bus 113 via an optical fiber cable from the central office of the telecommunications company. That information is processed in ONT unit 102, and forwarded to the appropriate customer equipment (phone, fax, TV, etc.) over bus 117. After the customer receives such information, e.g., a message from a calling party in a telephone call, then the customer speaks a reply which likewise provides a signal from CPE 103 via bus 117 to ONT unit 102 where it gets further processed before it gets forwarded via fiber optic line 113 to the central office and, thereafter, to its ultimate destination which in this example is the calling party.

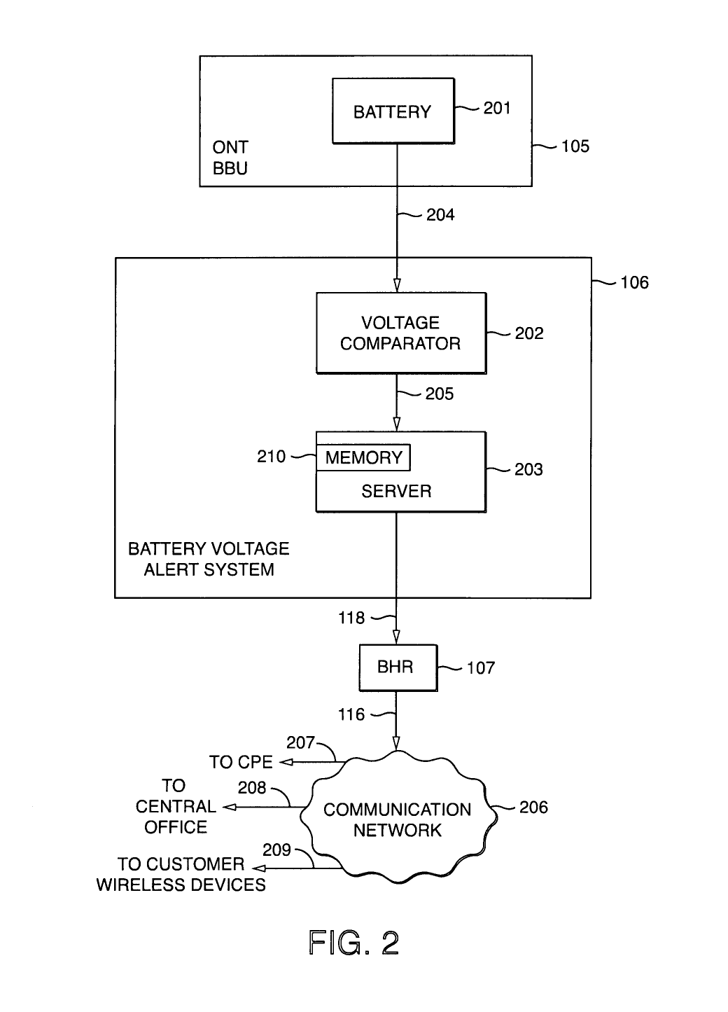

FIG. 2 is an exemplary block diagram of an ONT BBU battery voltage alert system (BVAS) 106 in operative connection in a network context, and in accordance with principles of the present invention. To enhance the presentation, rather than repeat ONT BBU BVAS, only BVAS shall be used as an equivalent designation hereinbelow. BVAS 106 is connected from ONT BBU 105 via battery voltage sampling lines 204 (these lines being included within bus 115 of FIG. 1) and is connected to BHR 107 via output alert signal line 118, also as shown in FIG. 1. BHR 107 is connected via link 116 to network 206, which may include any number of individual networks, local or wide-area, public or private (e.g., a LAN, the Internet), also as shown in FIG. 1. Alert signals are sent from server 203 via BHR 107 and network 206 to CPE 103 (phone, fax, email, etc.) via network link 207, to the central office of the telecommunication company supplier and/or to a third party dedicated to battery monitoring on a regional or national scale via network link 208, and to customer wireless devices (wireless telephone, blackberry, etc.) via network link 209. These alert signals are sent to various notification addresses. Server memory 210 can store a listing of these notification addresses which can be added to the server by the customer by way of an HTML interface. The customer would have access to this interface to allow the customer to set up its contact information and email addresses. The information and addresses could be stored in a flat file list and readily accessed when a notification is required by the server.

BHR 107 is a router and, in the preferred embodiment, typically can be model M1424WR by Actiontec or the equivalent. Alert signal line 118 can typically be a Category 5 copper Ethernet line using HTTP, POP, IMAP, TCP or UDP, and IP protocol. Network link 116 can typically include an Ethernet link carried over Category 5 copper line or a coaxial cable from BHR 116, and then converted into Gigabit Ethernet (GigE) over fiber optic cable using TCP/IP over GigE protocol, as is well known. Each of network links 207, 208 and 209 can typically include a Category 5 copper line or fiber optic cable using SONET (e.g., OC3, OC12, OC48), ATM, GigE, or MPLS protocols, as is well known. Other suitable lines, cables and protocols can be used can be used in implementing links. ONT BBU 105 includes battery 201 which may typically be a rechargeable lead acid or lithium battery.

BVAS 106 includes voltage comparator 202 and server computer 203. Voltage comparator 202 can be a conventional device that measures DC voltage between limits of zero (or negative) volts to at least positive twelve volts in an analog format and which converts those analog measurements to corresponding digital values. Typically, sampling of the analog measurement is made and those readings are then converted to digital equivalent values within voltage comparator 202 and which are then stored, or logged, in memory 210 within server computer 203. In the preferred embodiment, only readings of battery voltages which are less than the fully-charged battery voltage are logged. For example, if a fully charged battery in a particular embodiment is twelve volts, then any and all twelve volt readings are not recorded and logged. Normally, battery 201 remains fully charged for long periods of time, and storing/logging normal readings would be a waste of memory space. Thus, in the preferred embodiment, only readings reflecting any discharge of the battery from its fully charged status are logged.

However, if it were determined that maintenance of all voltage readings was desirable for statistical analysis or other reasons, then all actual voltage measurements could be stored at the time they were made if appropriate accommodation for storage of this additional information was taken into account. To conserve memory space, log storage can be accomplished in a manner which allows logs to be kept to a specific size. When the logs reach that size limit they may be transferred to a log storage space, e.g., on a network drive, for future reference. Alternatively, one could limit memory usage so that the older stored voltage measurements would fall off the log (log pruning) as new voltage measurements were written into memory. Log pruning shall ultimately result in loss of data, as compared with transferring the logs to a log storage space, but may be sufficient for certain usages of that data.

If battery 201 outputs less than full battery voltage, either due to discharging because of its being used in a backup capacity during utility company power failure, or because a cell of the battery fails regardless of the utility company's power status, or for any other reason, that battery output voltage is digitized in ONT BBU 105 and stored in memory 210. That battery output voltage is thereafter processed in server 203 into appropriate alert signals for routing via BHR 107 and network 206 to the customer and/or to the central office of the ONT supplier or battery service provider.

Server 203 can be based upon a miniature Linux kernel, also known as the “Busy Box” or DSL (“damn small Linux”) kernel. This server allows email functionality and http server functionality which are used to alert the customer to adverse battery conditions, if any. The server also acts as a logging mechanism to store information about the battery's condition, derived from scheduled battery checks. The battery voltage checks, or samples, are initiated by a scheduler implemented under Linux—in the preferred embodiment, the “cron” scheduler is used. Linux server 203 can be “Linux on a chip” and can be positioned internally to BBU 105, or can be a miniature Linux server located outside of BBU 105. It should be understood that other server configurations could be used and Linux is only one possible embodiment.

Linux server 203 can also contain scripts to control hardware in voltage comparator 202 that performs the battery voltage checks, and controls the processes that utilize stored data based on those checks. The data can be stored in a local database (on the customer site in, e.g., memory 210) or off-site (in remote storage). Remote storage permits the usage of a remote monitoring company dedicated to the monitoring of installed back-up batteries throughout a fiber-to-the-premises (FTTP) regional, or even national, area. Storage of this data allows maintenance of records related to voltage condition of battery 201 and to the number of low voltage events that may have occurred over a long period of time with respect to each installed battery. The miniature Linux kernel in server 203 also allows USB port, serial port and Ethernet port functionality.

Server 203 can use as its memory 210 a combination of non-volatile and volatile memory, as is well known. For example, in the preferred embodiment, a 2 GByte USB Flash drive may be used as a non-volatile “hard drive” and a 128 MByte SRAM memory chip as its volatile system memory, allowing it to run the basic Busy Box Linux kernel with the aforementioned scripts needed to provide required processes for voltage comparison and monitoring. The HTTP server functionality and serial port functionality allow for connectivity to a monitoring circuit such as voltage comparator 202. The serial connection can use an internal or external cable 205 to connect voltage comparator 202 to Linux server 203. USB is useful primarily for point-to-point communications, if there is need for connectivity to a personal computer (PC). (A PC would connect to server 203 via the USB port to enable a service technician to connect to the server through the PC if the need arose. There would be such a need if the provided IP connection became disabled for any reason. The USB port would then provide an additional point of entry from which trouble-shooting data could be derived.) The HTTP functionality is useful for control purposes and to serve up Web pages for viewing battery voltage logs. In the preferred embodiment, only deteriorated voltage measurements are logged, as noted above.

In further detail, BVAS 106 monitors condition of the battery by using conventional voltage comparison device 202 which can be fabricated from hardware chip(s) or discrete components. Voltage comparator 202 can provide a binary state output of “1” for a “no battery” condition or a negative voltage condition (battery polarity backwards). Voltage Comparator 202 can provide a binary state of “0” for the presence of a voltage indicating a battery with proper polarity. These outputs are stored in memory 210 and serve as input to a process in server 203, which provides necessary processing to permit emailing, text messaging, and contacting PDA's and pagers with notifications of, for example, a “no battery” condition.

Other, similar logic is employed to generate appropriate alert signals for a “marginal” condition where the battery voltage is less than fully charged but above a working threshold value, and for a “bad” condition where the battery voltage has deteriorated to less than that threshold value. For example, if twelve volts is considered to be the “fully charged” condition for the battery, the marginal condition can exist for any battery voltage less than twelve volts but greater than, for example, eight volts. In that case, the “bad” condition shall exist for any battery voltage of eight volts or less. Thus the preferred voltage comparator 202 includes the capability to detect, measure and indicate (in digital form) voltages over the range of the battery being monitored (in this example, zero volts to twelve volts).

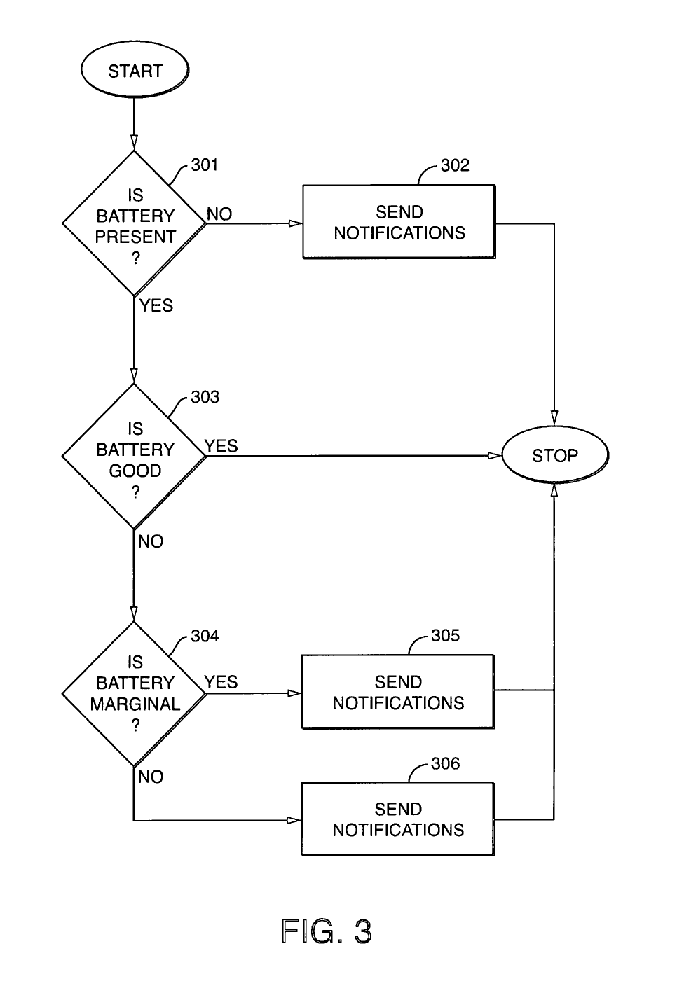

A software implementation for providing notification messaging, for example, could be based on a methodology capable of receiving measurements from voltage comparator 202 and storing the measurements in memory 210, parsing the measurements generated by voltage comparator 202 and stored in memory 210, and finding stored battery measurement values and then using the values in accordance with the flowchart logic of FIG. 3, to be discussed below. The software could also create the actual messages that are emailed, text messaged, or paged to various devices for notification. Linux server 203 would then be able to send the proper notification, for example, to a service that would then send the message to a pager, PDA, or any text messaging device. Additional functionality may include the ability to send the message to a facility that provides for email relay to any accounts needing the information. The particular software used is not as important as ensuring the software's ability to perform the functionality described herein. As an example, standard compiled software and/or interpreted shell scripts may be used in connection with server 203 to implement software to implement the functionality described above.

FIG. 3 is a flowchart of operation of an embodiment of the present invention. The process starts with voltage comparator 202 making a measurement of the battery and generating an appropriate indication, which will be detected by the software of server 203 and stored in memory 210 for use in the notification process. As noted above, this indication may include state information (no battery detected, battery detected OK, battery marginal, battery bad) and/or actual voltage measurements in digital form. Measurement by voltage comparator may be continuous, periodic (e.g., once per day) or on the occurrence of an event (e.g., a button press). Detection and storage by the software of server 203 may likewise be performed on a periodic basis (e.g., once per day) or based on the occurrence of an event (e.g., button press).

Decision block 301 queries: is battery 201 present? If there is no battery in place the reading will be zero volts. If the polarity of battery 201 is reversed by mistake, that is essentially equivalent to no battery present, but will give a negative voltage reading. If for either of these two conditions the answer is “no” (which may be indicted by an appropriate measurement stored in memory 210), “send notifications” block 302 is executed by server 203 which sends appropriate email, paging, telephone call, etc. notifications to the relevant customer over the network 206 by way of the server operation discussed above. A typical notification could include the customer's email address, the battery condition that triggered the alarm, the time and date of the alarm, and a message advising the customer to contact its ONT supplier if it starts to receive additional notifications on a repetitive or continuous basis. If these notifications are frequent, the ONT supplier could then have its service personnel come to the customer's premises to physically check the battery and to replace it as may be required.

On the other hand, if the answer to the query in decision block 301 is “yes” then a battery does exist and it had been installed into ONT BBU properly to allow the correct polarity. According to the algorithmic process depicted, another inquiry is required and is made in decision block 303: Is battery 201 good? The battery is checked for proper status/voltage and if it has been recorded as in good condition (e.g., the absence of any recorded measurements over a certain time period), then the battery is rated “good.” A good battery is the norm and no action need be taken

However, if the answer to the query made in decision block 303 is “no”, then the battery is not good and the degree of deterioration of the battery may be determined. The algorithmic process moves to decision block 304 wherein the query is made: Is battery 201 “marginal?” Server 203 may compare the recorded battery measurements to determine if the battery's voltage falls within the “marginal” range. In accordance with the example provided above, a twelve volt battery is good, and any reading between less than twelve volts and greater than eight volts is considered to be “marginal.” If the battery voltage output, at the time of this query is, for example, ten volts, then the battery output voltage falls into the marginal category. The answer to the question in decision block 304 would then be “yes.” Accordingly, notifications would be sent by “send notifications” block 305 which, again, would be one or all of email, telephone call, fax, text message, etc. made to the customer associated with the ONT for which this battery is the backup battery.

On the other hand, if the output voltage from the battery is eight volts or less, then the answer to the query in block 304 is “no.” This means the battery falls into the “bad” category and shall fail very soon; this becomes an urgent matter and notifications are sent by “send notifications” block 306. In this case, notifications may be sent not only to a customer but also to the telecommunications company supplier of the customer's ONT and/or a battery service provider.

Where the process of FIG. 3 is performed upon the occurrence of event, once notifications are sent (or it has been determined that no notifications need to be sent), the process may end. Alternatively, where the process of FIG. 3 is performed periodically (e.g., once per day), the process can be repeated indefinitely. Thus, in the case where a battery is failing (or has already failed, including a missing battery or polarity problem), notifications may be sent periodically until the problem is rectified.

Referring back to FIG. 1, it can be seen that ONT power supply 104 powers BVAS 106 via power line 112. Thus, when utility company power is available, it powers BVAS 106. However, if power from the utility company is interrupted, the battery in ONT BBU 105 functions as substitute power for ONT unit 102. Its battery voltage output deteriorates as a result. Since ONT BBU 105 also backup-powers BVAS 106 via line 115, voltage requirements for operating BVAS 106 must be designed small enough to operate under conditions of deteriorating voltage level from battery 201. For example, in a particular embodiment, BVAS 106 is designed to operate with a five volt supply so that it can continue to operate until voltage deteriorates from twelve volts down to five volts, well-into the “bad” battery voltage zone, to allow “bad” notifications to be forwarded to the customer and to the ONT supplier, before it also shuts down from lack of power.

On the other hand, if there is a battery cell failure, without a utility company power failure, the battery voltage will drop accordingly even though the battery is subjected to a charging voltage. In this case, even if the battery voltage dropped below five volts due to multiple cell failure, BVAS 106 would continue to operate because it is being powered by ONT power supply 104, deriving its power from the utility company, and not by the battery.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. For example, if a battery is missing, or inserted with wrong polarity, the monitoring of that condition can be conducted over a series of predetermined time intervals until that condition is rectified. For another example, there can be more categories of battery deterioration that are reported, rather than only “marginal” and “bad.” Accordingly, the specification and drawings are accordingly to be regarded in an illustrative rather than restrictive sense.

What is claimed is:

1. A low battery-voltage warning system comprising:
a voltage monitoring device for monitoring voltage of a battery used as a back-up power supply for an optical network terminal (ONT) installed on customer premises and for providing an indication of degree of discharge of said battery; and
a server computer, receiving said indication as input information, for processing said input information into output information suitable for immediate communication to said customer.

2. The warning system of claim 1 wherein said communication is accomplished via email.

3. The warning system of claim 1 wherein said communication is accomplished via text-messaging.

4. The warning system of claim 1 wherein said communication is accomplished via land-line telephone call.

5. The warning system of claim 1 wherein said communication is accomplished via wireless telephone call.

6. The warning system of claim 1 wherein said communication is accomplished via a paging alert.

7. The warning system of claim 1 wherein said communication is accomplished via communication to a personal digital assistant (PDA) of said customer.

8. The warning system of claim 1 wherein said server computer further processes said input information into output information suitable for immediate communication to a supplier of said ONT, thereby alerting said supplier to either replace said battery or notify said customer to replace said battery.

9. The warning system of claim 1 wherein said battery voltage should be twelve volts when fully charged and wherein said communication indicates that said degree of discharge is marginal for values of said battery voltage below said twelve volts and above eight volts.

10. The warning system of claim 9 wherein said communication indicates that said degree of discharge is bad for values of said battery voltage equal to or less than said eight volts.

11. The warning system of claim 1 wherein said monitoring is continuous allowing sampling of said monitored voltage.
